(19) United States
(12) Patent Application Publication
(10) Pub. No.: US 2013/0302121 A1
(43) Pub. Date: Nov. 14, 2013

(54) Passenger Lift for Reaching Elevated Access Openings

(71) Applicants: Stuart Allan Marrin, Winnipeg (CA); William Edward Pastrick, Winnipeg (CA)

(72) Inventors: Stuart Allan Marrin, Winnipeg (CA); William Edward Pastrick, Winnipeg (CA)

(21) Appl. No.: 13/466,568

(22) Filed: May 8, 2012

(51) Int. Cl. B64F 1/30; A61G 3/06

(52) U.S. Cl. 414/495

(57) ABSTRACT

A passenger lift for loading a passenger to and from an elevated access opening features a wheeled frame, a first parallelogram linkage coupled to the frame proximate a first end thereof and a second parallelogram linkage pivotally coupled to an output link of the first linkage. A passenger platform is pivotally carried on the output link of the second linkage. Through pivoting of the linkages by respective actuators, the passenger platform is movable between a lowered position adjacent a second end of the frame, and raised positions in which the platform is situated nearer the first end of the frame. The frame is open at the first end to define a gap between side members of the frame to accommodate a lower end of a staircase for accessing the elevated access opening. The platform thus forms an approach to the staircase when the platform is in the lowered position.

### FIELD OF THE INVENTION

The present invention relates generally to passenger lifts, and more particularly to mobile passenger lifts used to load and unload aircraft at elevated access openings thereof.

### BACKGROUND OF THE INVENTION

Aircraft passengers that are wheelchair-bound or face other mobility challenges can face difficulties in boarding and disembarking an aircraft, particularly in situations where no access ramp is provided between the aircraft and the airport terminal and a stairway is instead the primary access-way to the aircraft's passenger door situated well above ground level.

Accordingly, it is known in the prior art to provide a mobile passenger lift that can be deployed for loading such passengers. The lift is wheeled to a position near the aircraft opening at ground level therebelow. The passenger, typically accompanied by an assistant, rides a basket that is lifted up to the aircraft opening by a pair of rigid support arms that are disposed on opposite sides of the basket and each pivotally coupled between the basket and the wheeled frame of the lift. Examples of such lifts are disclosed in U.S. Pat. Nos. 4,971,510, 5,595,470 and 6,062,809.

Applicant has developed a new passenger lift having unique features that provide advantages over the basic configuration shared by the lifts in the aforementioned prior art patents.

### SUMMARY OF THE INVENTION

According to a first aspect of the invention there is provided a passenger lift for loading a passenger into and out of a structure having an elevated access opening, the passenger lift comprising:

a frame having a first end, and a second end opposite the first end;

wheels rotatably attached to the frame for rolling engagement with ground to enable travel of the frame over the ground;

a first parallelogram linkage comprising a first pair of parallel arms each having a first pivotal connection to the frame proximate the first end thereof, and a first output link pivotally connected between the first pair of parallel arms at a first distance from the first pivotal connections;

a second parallelogram linkage comprising a second pair of parallel arms each pivotally carried on the output link of the first parallelogram linkage, and a second output link pivotally connected between the second pair of parallel arms at a second distance from the second pivotal connections;

a passenger platform carried on the second parallelogram linkage by third pivotal connections pivotally connecting the passenger platform to the second parallelogram linkage at the second output link;

a first actuation device coupled to the first parallelogram linkage and operable to effect movement thereof relative to the frame by pivoting of the first pair of parallel arms about the first pivot points; and

a second actuation device coupled to the second parallelogram linkage and operable to effect movement thereof relative to the first parallelogram linkage by pivoting of the second pair of parallel arms about the second pivot points;

the passenger platform, by pivoting of the parallel arms of the parallelogram linkages relative to the frame, being movable between a lowered position, in which the parallelogram linkages extend toward the second end of the frame from the first pivotal connections to position the platform adjacent the second end of the frame, and raised positions in which the platform is situated nearer the first end of the frame, and at a greater elevation, than in the lowered position.

Preferably there is provided a ramp device carried on the frame adjacent the second end thereof and deployable to form a pathway from the ground to where the platform resides when in the lowered position.

Preferably the frame is open at the first end thereof and defines a gap that extends between side members of the frame from the open first end thereof to a location adjacent to where the platform resides when in the lowered position, whereby the platform forms an approach to the gap when the platform is in the lowered position.

There may be provided at least one biasing device each arranged to act on a corresponding one of the parallelogram linkages to bias the platform out of the lowered position.

The at least one biasing device may comprise first and second biasing devices acting on the first and second parallelogram linkages respectively.

Preferably the first actuation device comprises a first hydraulic actuator connected between the frame and the first parallelogram linkage, and the second actuation device comprises a second hydraulic actuator connected between the first and second parallelogram linkages.

Preferably the platform is supported on the frame from only one side of the platform.

According to a second aspect of the invention there is provided a passenger lift for loading a passenger into and out of a structure having an elevated access opening that is also accessible by a staircase, the passenger lift comprising:

a frame having a first end, and a second end opposite the first end;

wheels rotatably attached to the frame for rolling engagement with ground to enable travel of the frame over the ground;

a passenger platform carried on the frame and movable relative thereto between a lowered position and raised positions in which the platform is situated nearer the second end of the frame, and at a greater elevation, than in the lowered position;

wherein the frame is open at the first end thereof and defines a gap that extends between side members of the frame from the open first end thereof to a location adjacent to where the platform resides when in the lowered position, the gap being sufficiently wide between the side members of the frame to accommodate a lower end of the staircase, whereby the platform forms an approach to the staircase when the platform is in the lowered position and the frame is positioned to receive the lower end of the staircase between the side members.

Preferably there is provided a ramp device carried on the frame adjacent the second end thereof and deployable to form a pathway from the ground to where the platform resides when in the lowered position.

Preferably there is provided a cross-member spanning across the gap at an end thereof opposite the open second end of frame

Preferably an elevation of the platform, when in the lowered position, corresponds to an elevation of the cross-member.

Preferably the ramp device is carried on another cross-member extending between the side members adjacent the second end of the frame and movable into and out of a stowed position raised from the ground.

Preferably the ramp is pivotally mounted on the cross-member to swing between the stowed position, in which the ramp extends toward the first end of the frame in a position overlying the platform's lowered position, and a deployed position sloping down to the ground from the cross-member in a direction away from the first end of the frame.

According to a third aspect of the invention there is provided a passenger lift for loading a passenger into and out of a structure having an elevated access opening, the passenger lift comprising:

a frame having a first end, and a second end opposite the first end;

wheels rotatably attached to the frame for rolling engagement with ground to enable travel of the frame over the ground;

a passenger platform carried on the frame by at least one linkage; and

an actuation device coupled to the linkage and operable to effect movement thereof relative to the frame to raise and lower the passenger platform relative to the frame between a lowered position proximate the frame and raised condition of greater elevation than the lowered position; and

a biasing mechanism arranged to bias the linkage toward a raised position corresponding to the raised condition of the passenger platform.

Preferably the actuation device comprises a hydraulic actuator.

The biasing mechanism may comprise a spring acting between the frame and the linkage.

The biasing mechanism may comprise a coil spring coiled around the hydraulic actuator.

### BRIEF DESCRIPTION OF THE DRAWINGS

In the accompanying drawings, which illustrate exemplary embodiments of the present invention:

FIG. 1 is a perspective view of a first embodiment passenger lift of the present invention from a first end thereof, with its rider platform thereof in a fully lowered position and its access ramp in a stowed position.

FIG. 2 is a perspective view of the passenger lift of FIG. 1 from a second end thereof, with its rider platform and access ramp in the same positions.

FIG. 3 is a side elevational view of the passenger lift of FIG. 1, with its rider platform and access ramp in the same positions.

FIG. 4 is an end elevational view of the passenger lift of FIG. 1 from the first end thereof, with its rider platform and access ramp in the same positions.

FIG. 5 is a perspective view of the passenger lift of FIG. 1 from a first side thereof with its access ramp in a deployed position and its rider platform in a first elevated position resulting from extension of only one of two linkages that carry the rider platform on a frame of the lift.

FIG. 6 is perspective view of the passenger lift of FIG. 5 from a second side thereof with its access ramp and rider platform in the same positions.

FIG. 7 is a perspective view of the passenger lift of FIG. 1 from the first side thereof with its access ramp in the deployed position and its rider platform in a second elevated position resulting from extension of only the other of the two platform-carrying linkages.

FIG. 8 is perspective view of the passenger lift of FIG. 7 from the second side thereof with its access ramp and rider platform in the same positions.

FIG. 9 is a perspective view of the passenger lift of FIG. 1 from the first side thereof with its access ramp in the deployed position and its rider platform in a third elevated position resulting from extension of both of the two platform-carrying linkages.

FIG. 10 is perspective view of the passenger lift of FIG. 9 from the second side thereof with its access ramp and rider platform in the same positions.

FIG. 11 is a schematic side elevational view of the passenger lift of FIG. 1 with its access ramp in the deployed position, its rider platform in the fully lowered position, and with actuator springs and one of two mounting walls on the frame omitted to show a connection between one of the platform carrying linkages and its actuator.

FIG. 12 is a perspective view of a second embodiment passenger lift of the present invention from a first end thereof, with its rider platform thereof in a fully lowered position and its access ramp in a stowed position.

FIG. 13 is a perspective view of the passenger lift of FIG. 12 from a second end thereof, with its rider platform and access ramp in the same positions.

FIG. 14 is a side elevational view of the passenger lift of FIG. 12, with its rider platform and access ramp in the same positions.

FIG. 15 is an end elevational view of the passenger lift of FIG. 12 from the first end thereof, with its rider platform and access ramp in the same positions.

FIG. 16 is a perspective view of the passenger lift of FIG. 12 from a first side thereof with its access ramp in a deployed position and its rider platform in a first elevated position resulting from extension of only one of two linkages that carry the rider platform on a frame of the lift.

FIG. 17 is perspective view of the passenger lift of FIG. 16 from a second side thereof with its access ramp and rider platform in the same positions.

FIG. 18 is a perspective view of the passenger lift of FIG. 12 from the first side thereof with its access ramp in the deployed position and its rider platform in a second elevated position resulting from extension of only the other of the two platform-carrying linkages.

FIG. 19 is perspective view of the passenger lift of FIG. 18 from the second side thereof with its access ramp and rider platform in the same positions.

FIG. 20 is a perspective view of the passenger lift of FIG. 12 from the first side thereof with its access ramp in the deployed position and its rider platform in a third elevated position resulting from extension of both of the two platform-carrying linkages.

FIG. 21 is perspective view of the passenger lift of FIG. 20 from the second side thereof with its access ramp and rider platform in the same positions.

FIG. 22 is a cross sectional view of the passenger lift of FIG. 12 with its access ramp in the deployed position and its rider platform in the fully lowered position, the cross-sectional view showing a connection between one of the platform carrying linkages and its actuator.

### DETAILED DESCRIPTION

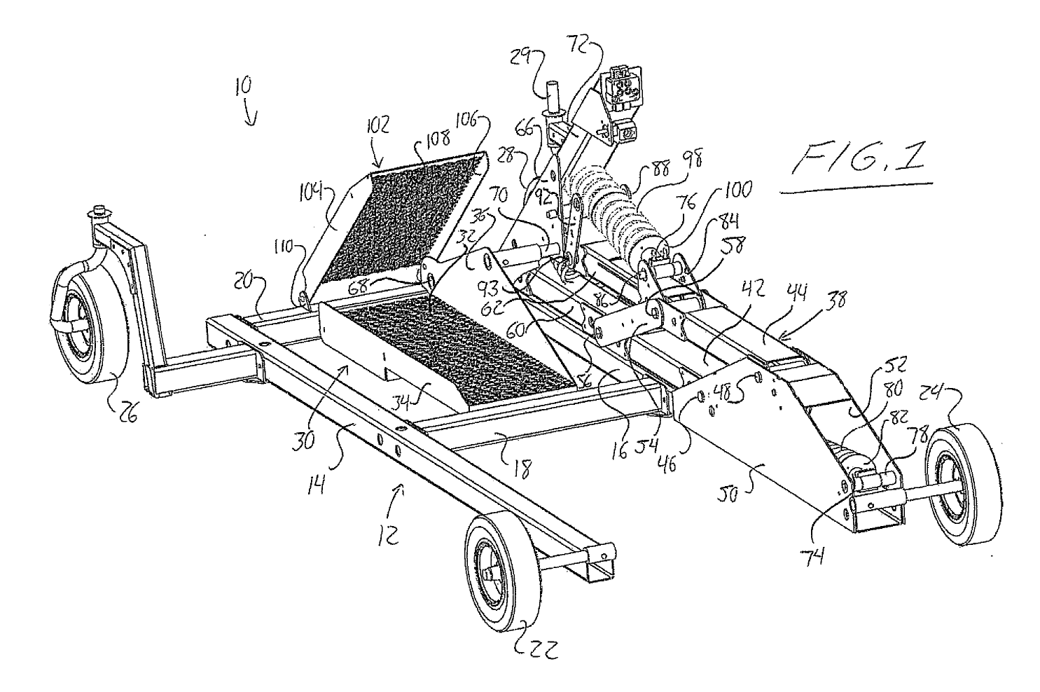

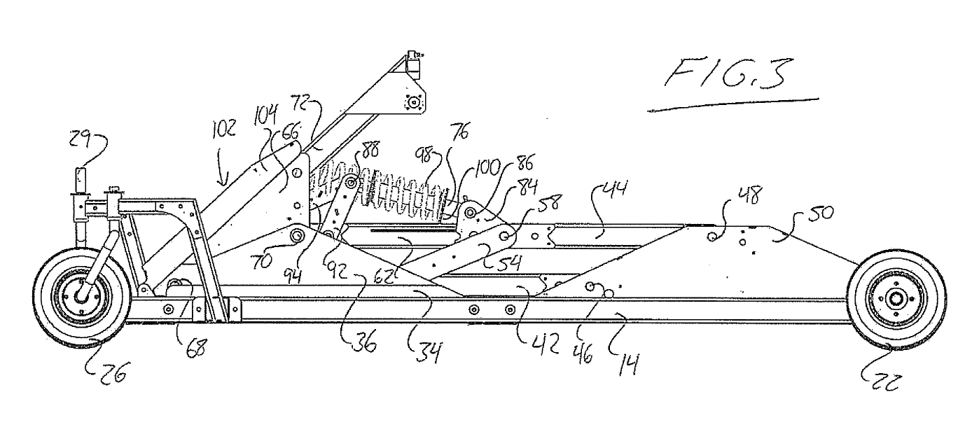

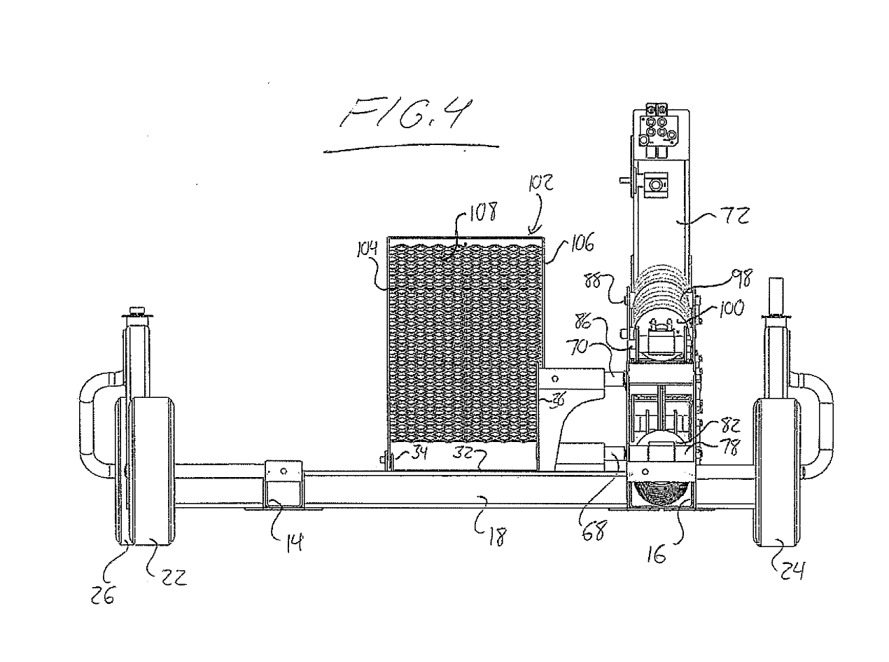

The passenger lift 10 of the first embodiment of the present invention shown in FIGS. 1 to 11 features a frame 12 that includes two parallel side members 14, 16 extending horizontally in a longitudinal direction of the frame at positions spaced apart from one another in a transverse direction orthogonal thereto. The side members are interconnected with one another and maintained in this laterally spaced apart condition by two cross-members 18, 20.

An open first end of the frame lacks such a cross-member and features a pair of fixed-axis wheels 22, 24 that are mounted respectively at the corresponding ends of the side members 14, 16 and share a stationary rotational axis that extends horizontally across the frame in the transverse direction, and about which each of these wheels 22, 24 is rotatable. Rolling support of the frame 12 on the ground is completed at the opposite second end of the frame 12 by a castering wheel 26 and a steerable wheel 28, each of which is also connected to a respective one of the side members 14, 16. Unlike the wheels at the first end, the other wheels 26, 28 are each allowed to swivel about a vertical axis of a respective wheel support arm, and thus lack a fixed axis of rotation. A handle 29 disposed atop the wheel support arm of the steerable wheel 28 allows an operator to control the swivel of the arm to steer the vehicle when towed by a vehicle or otherwise pushed or pulled over the ground. The castering wheel is positioned further outboard from the frame than the other wheels to provide sufficient clearance between the wheel's swivel axis and the frame. The castering wheel's support arm depends vertically downward at first to define the vertical swivel axis, and then slopes downward and rearward at an oblique angle to set the wheel's rotational axis in a position trailing the vertical swivel axis, for example by about ⅓ of the wheel diameter, in order to provide the caster functionality.

An end one 20 of the two cross members 18, 20 extends between the side members 14, 16 at the caster-wheeled second end of frame, with the other cross-member defining a more central cross-member 18 located generally midway along the longitudinal dimension of the frame 12. In the illustrated embodiments, the frame members 14, 16, 18, 20 and the caster wheel support members are all formed, at least in part, by metal rectangular tubing.

A passenger platform 30 of the lift 10 features a horizontally-oriented rectangular floor panel 32, preferably in the form of a metal grating or other perforated material to prevent pooling of liquid or other material on the platform 30 under exposure to elements (rain, snow, etc.) during outdoor use of the lift. A short side wall 34 projects perpendicularly upward from the floor panel 32 at a side thereof nearest the first one 14 of the frame's side members 14, 16. At an opposing side of the floor panel 32, a taller but parallel side wall 36 projects further upward from the floor panel 32, and the resulting greater wall area above this second side of the floor panel 32 provides for connection of the platform 30 to the linkages that operate to raise and lower the platform, as described further herein further below. The side walls 34, 36 of the passenger platform 30 each reach down to below the floor panel 32 positioned between them, so as to interconnect across the bottom of the floor panel at multiple positions therealong to provide strength and rigidity to the overall platform 30.

Connection between the frame 12 of the lift and the rider platform 30 thereof is provided by two parallelogram linkages 38, 40. The first linkage 38 features two equal-length parallel links 42, 44, each of which is pivotally connected to the frame via a respective pivot pin 46, 48 that is supported over the second side member 16 of the frame and extends across this side member 16 in the transverse direction of the frame. These pivot pins 46, 28 are supported by a pair of parallel mounting walls 50, 52 extending vertically upward from the second side member 16 on opposing sides thereof between the central cross-member 18 and the open end of the frame. In the illustrated embodiments, the two parallel links 42, 44 are formed in part by respective lengths of metal rectangular tubing. An output link of the first linkage 38 is provided by a pair of plate links 54 aligned with one another from opposite sides of the parallel links 42, 44, and joined with one another through the parallel links for movement together by two pivot pins 56, 58 each passing through a respective one of the parallel links 42, 44 proximate the end thereof opposite the pivotal connection 46, 48 to the mounting walls 50, 52 of the frame 12.

The pivot pins 56, 58 forming the pivotal connection of the first linkage's output link 54 to the longer parallel links 42, 44 thereof also form the pivotal connections between the first parallelogram linkage 38 and a second pair of equal-length parallel links 60, 62 forming part of the second parallelogram linkage 40. That is, the first output link's first pivot pin 56 pivotally connects that output link and the first linkage's first parallel link 42 to the second linkage's first parallel link 60, and likewise the first output link's second pivot pin 58 also pivotally connects that output link and the first linkage's second parallel link 44 to the second linkage's second parallel link 62. The output link 54 of the first parallelogram linkage 38 thus also forms the base link of the second parallelogram linkage 40. An output link 64 of the second linkage 40 is provided in part by a pair of identical plates 66 aligned with one another from opposite sides of the same linkage's parallel links 60, 62 and joined with one another through these parallel links for movement together by two pivot shafts 68, 70 each passing through a respective one of the parallel links 60, 62 proximate the end thereof opposite the pivotal connection 56, 58 to the output link 54 of the first linkage 38. Another part of the output link 64 is provided by another piece of rectangular tubing 72 fixed between the output link's plates 66 past the output ends of the second linkage's parallel links 60, 62 so as to project outwardly past only the second one 62 of those parallel links.

The ends of the pivot shafts 68, 70 extend inwardly from the output link plates 66 of the second linkage 40 in the transverse direction of the frame to connect to the taller side wall 36 of the passenger platform 30 on the side thereof nearest the linkage-equipped side member 16 of the frame. Accordingly, the passenger platform 30 moves with the second linkage 40, and being coupled to the output link 66 of this parallelogram linkage by the pivot shafts 68, 70, maintains a horizontal orientation of the platform's floor panel 32 throughout such motion, as this output link 66 maintains a constant orientation relative to the frame 12 due to the parallelogram configuration of the two linkages.

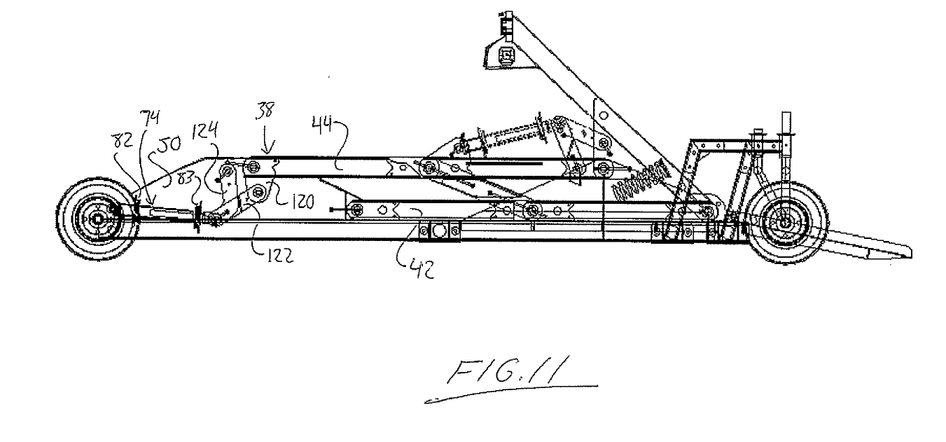

Actuation of each linkage 38, 40 is effected by a respective hydraulic actuator 74, 76. The first hydraulic actuator 74 has a closed end of its cylinder pivotally suspended between the mounting plates 50, 52 just above the side member 16 of the frame 12 by a pin 78 transversely crossing over the side member 16 near the frame's open end. With reference to FIG. 11, the piston rod projecting from the opposite end of the cylinder is coupled to the first linkage at a pair lug plates 120 projecting from the second parallel link 44 to the side thereof on which the first parallel link 42 is disposed at the end of the second link 44 pivotally mounted to the mounting walls 50, 52. This connection of the piston rod to the lug plates 120 is achieved via a straight connecting link 122 pivotally coupled to the piston rod at one end and to a pivot pin on the lug plates 122 at the other end. An elbow link arm 124 has one end pivotally coupled to the distal end of the piston rod for pivoting relative thereto about a same transverse axis as the straight connecting link 22. The elbow link 124 initially extends from the cylinder partially along the straight connecting link 122 before curving or bending back toward the open end of the frame, where it is pivotally carried between the mounting walls 50, 52 near the upper edges thereof a short distance toward the open end of the frame from the wall-mounted end of the first linkage's second link 44. A first coil spring 80 is coiled around the first actuator 74 to act between a stop plate 82 that is fixed on the cylinder near the closed end thereof to present an annular flange projecting radially outward therefrom, and a second stop plate 83 fixed on the piston rod to present an annular flange projecting radially outward therefrom between the cylinder and the piston rod's distal end. The frame's side member 16 below the linkages is at least partially formed by an upwardly opening channel member running along the bottom edges of the mounting walls 50, 52. The side walls of the channels square-U-shaped cross-section are fixed to the mounting walls 50, 52, with the closed bottom of the square-U-shape spanning between them. The open top of this channel accommodates parts of the first linkage's actuation mechanism, as can be seen in FIG. 11 where parts of the cylinder, piston rod, second stop plate, straight connecting link and elbow link arm are disposed at elevations below the top of the frame's side member 16.

The second hydraulic actuator 76 has the closed end of its cylinder pivotally suspended on a pin 86 transversely crossing between a pair of lug plates 84 that are fixed on opposite sides of the second parallel link 44 of the first linkage 38 to carry the pin 86 on a side of the second link 44 of the first linkage 38 opposite the first link 42 thereof. The piston rod projecting from the opposite end of the second cylinder is pivotally coupled to another pin 88 that extends transversely between a pair of pivotal lug plates 90. This second pair of lug plates 92 project from their pivotal connection 93 to the second parallel link 62 of the second linkage to the side thereof opposite the first parallel link 60 of the second linkage, so as to position the respective pin 88 on the same side of the second linkage as the pin 86 between the first pair of lug plates 84. A connecting link 94 has one of its ends pivotally journaled on the same pivot shaft 88 as the second actuator's piston rod, and its other end pivotally journaled on another pin 96 that extends between the output link plates 66 of the second linkage 40 at a position past the end of the second linkage's second parallel link 62. A second coil spring 98 is coiled around the second actuator 76 to act between a stop plate 100 that is fixed on the cylinder near the closed end thereof to present an annular flange projecting radially outward therefrom and another stop plate 101 fixed on the piston rod to present an annular flange projecting radially outward therefrom between the cylinder and the piston rod's distal end.

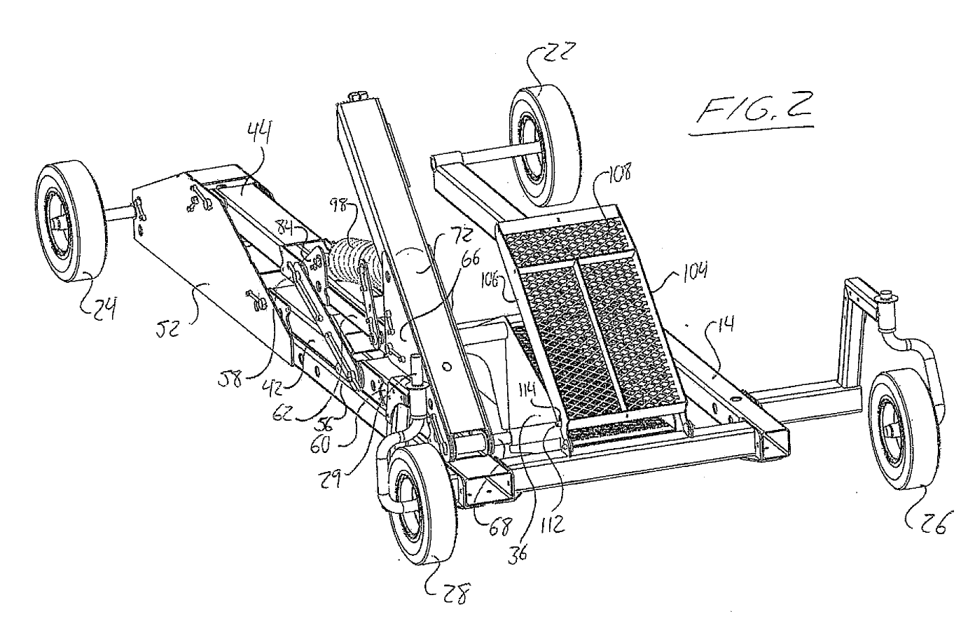

A ramp assembly 102 has a similar structure to the passenger platform, in that it has two side walls 104, 106 having a mesh or grate floor panel 108 spanning perpendicularly between them with a framework of cross-pieces likewise spanning between the side walls 104,106 across the underside of the floor panel 108. At one end of the ramp assembly 102, the ends of the side walls 104 are pivotally mounted to a pair of vertically upstanding lugs 110 projecting from the top of the end cross member 20 of the frame 12. With reference to FIG. 2, a stop pin 112 projects laterally outward from the taller side wall 36 of the passenger platform 30 proximate the rear end thereof to cooperate with a slot 114 into the corresponding side wall 106 of the ramp assembly 106 from the top edge of the wall disposed above the ramp's floor panel 108 to form a stop that defines a stowed position of the ramp when not in use, as described in further detail below.

FIGS. 1 to 4 show the passenger platform 30 in a fully lowered position in which it resides between the two cross-members 18, 20 with the top surfaces of the floor panel 32 lying substantially co-planar with the top surface of the two cross-members. In the same figures, the ramp assembly 102 is shown in a stowed position sloping obliquely upward from the end cross-member 20 of the frame to partially overlie lowered passenger platform 30. The stop pin 112 is fixed on the passenger platform side wall 36, and its engagement against the closed end of the slot 114 in the respective ramp assembly side wall 106 supports the ramp assembly in this position, where the ramp's floor panel 108 overlies the platform side walls without contacting the upper edges thereof. This positioning of the ramp and passenger platform puts the overall passenger lift apparatus in a compact state suitable for transport and storage.

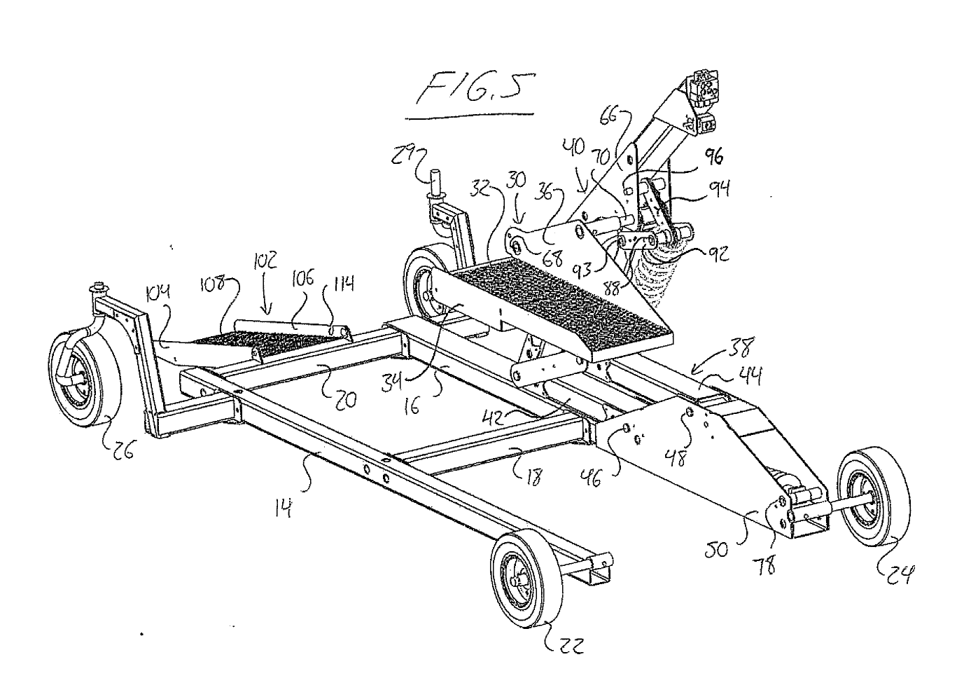

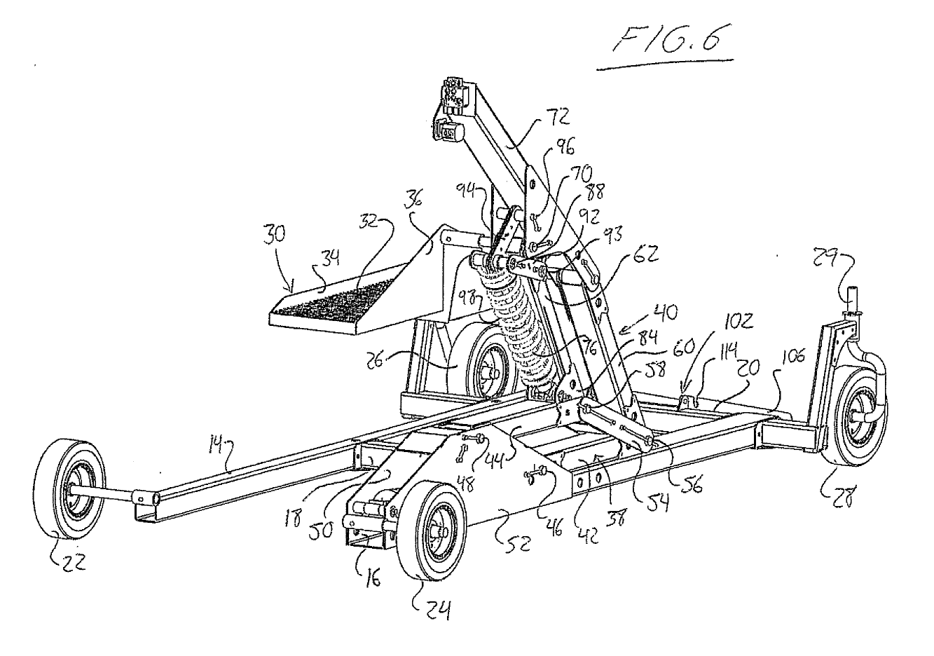

FIGS. 5 and 6 show the passenger platform 30 in a first elevated position raised above the frame through pivoting of the second linkage 40, but not the first linkage 38, relative to the frame 12. To raise the platform to this position from the lowered position of FIGS. 1 through 4, the second actuator 76 is extended from its initial position, thereby pushing pin 88 at the piston rod end of the actuator away from the pin 86 at the closed cylinder end of the actuator 74 toward the output link 66, 72 of the second linkage. With movement of the pin 88 being constrained by its connection to the second linkage's second parallel link 62 by the lug arms 92 and its connection to the second linkage's output link 66, 72 by the connecting link 94, and the second linkage's output link 66, 72 being constrained by its connection to the first linkage's output link 54 by the second linkages parallel links 60, 62, the extending force of the actuator 76 pivots the parallel links 60, 62 of the second linkage away from the frame about their pivotal connection 56, 58 to the first linkage to accommodate the extension of the actuator's piston rod. Through this action, the second parallelogram linkage pivots from its initial lowered position of FIGS. 1 to 4, in which it lies parallel to the first linkage with its first link 60 lying horizontally flat atop the side member 16 of the frame, through an obtuse angle about its pivotal connections 56, 58 to the output link 54 of the first linkage 38 into the position of FIGS. 5 and 6, where it lies at an acute oblique angle relative to the first linkage.

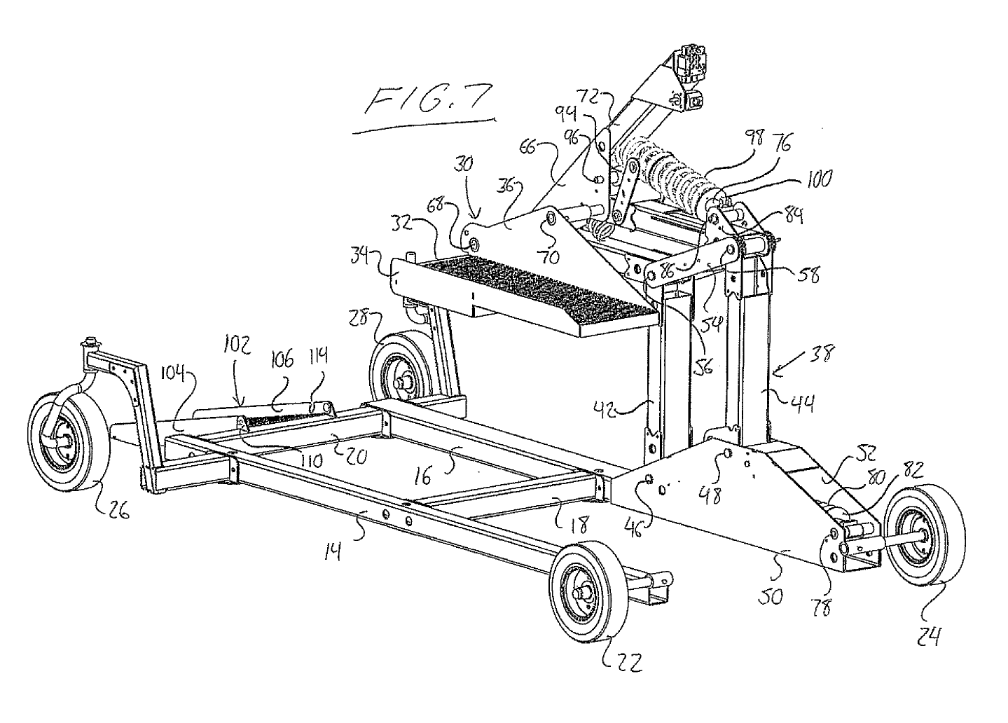

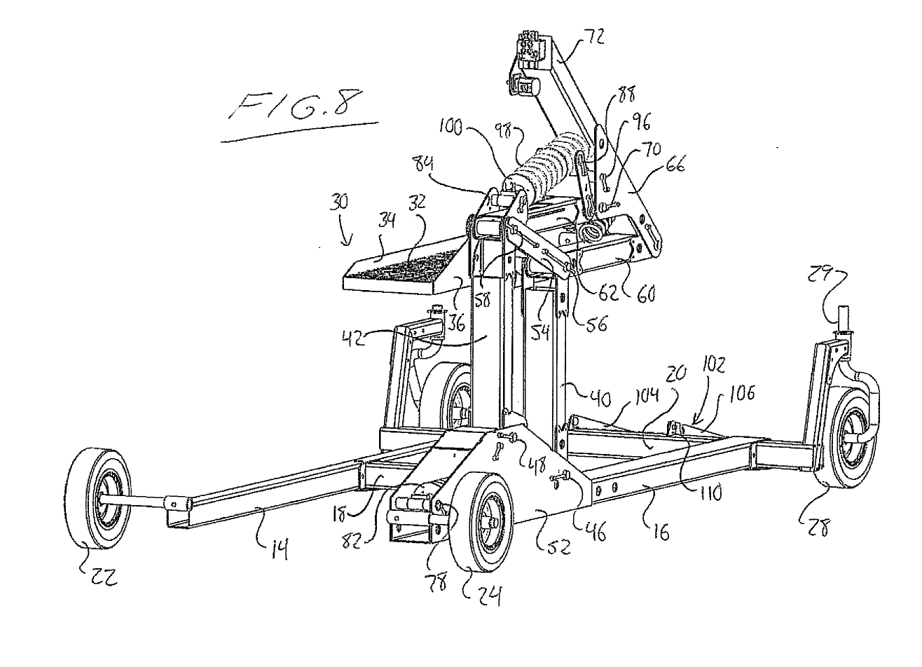

FIGS. 7 and 8 show the passenger platform in a second elevated position raised above the frame through pivoting of the first linkage 38, but not the second linkage 40, relative to the frame 12. To raise the platform to this position from the lowered position of FIGS. 1 through 4, the first actuator 74 is extended from its initial position, thereby pushing the lug plates 120 (FIG. 11) on the first linkage's second link 44 toward the closed end of the frame via the straight connecting link 122, thus pivoting the second link 44 about its pivotal connection to the mounting walls 50, 52 in a direction upwardly away from the frame and toward the open end thereof. Due to the parallelogram configuration of the linkage, the parallel links 40, 42 move together, thus also pivoting the first link 42 about its pivotal connection to the mounting plates 50, 52 of the frame 12 toward the frame's open end. This in turn pulls the output link 54 of the first linkage 38 toward the open end of the frame 12. Through this action, the first parallelogram linkage pivots from its initial lowered position of FIGS. 1 to 4, in which its first link 40 lies horizontally flat atop the side member 16 of the frame, through a ninety-degree angle about its pivotal connections 46, 48 to the mounting plates 50, 52 of the frame into the position of FIGS. 7 and 8, where it lies at a perpendicular angle relative to the side member 16 of the frame. As any actuation of the second linkage occurs relative to the output link 54 of the first linkage, the second linkage remains horizontally oriented (i.e. parallel to the frame's side member) in the absence of any actuation of the second actuator during operation of the first actuator.

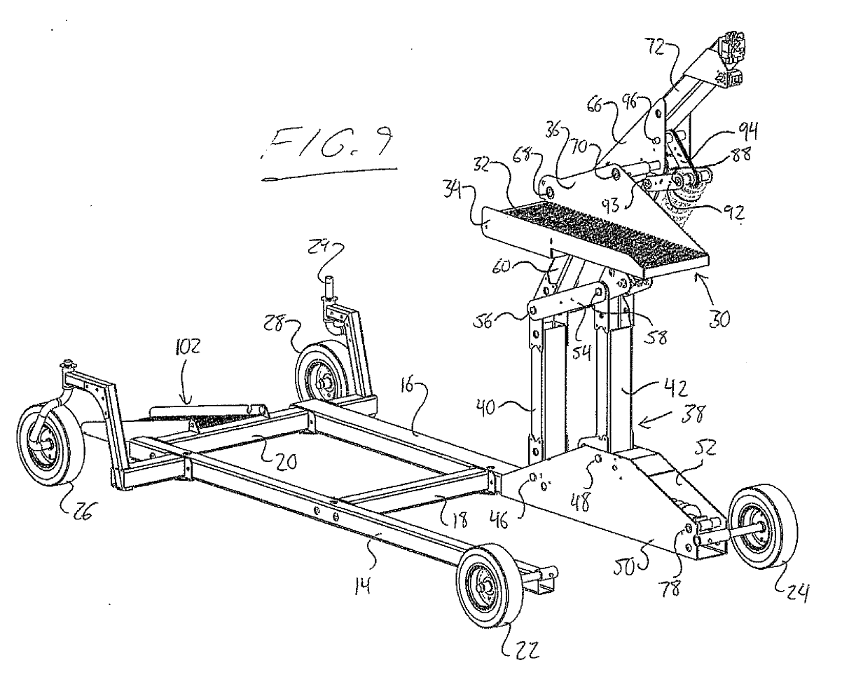

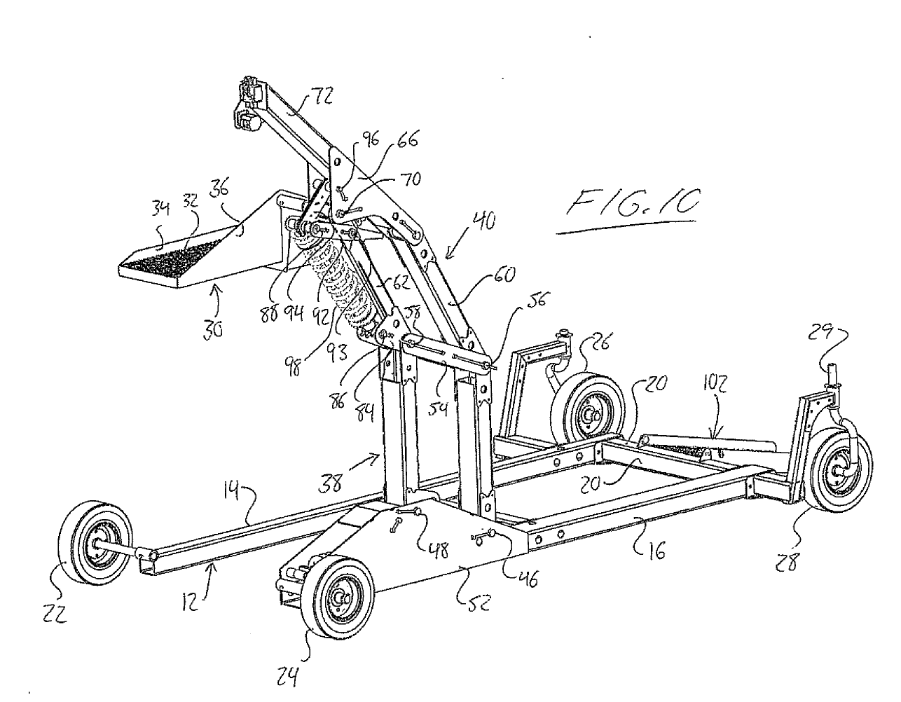

FIGS. 9 and 10 show the passenger platform in a third elevated position raised above the frame through pivoting of both the first and second linkages 38, 40 to their maximum limits from their default lowered positions parallel to the horizontal plane of frame members 14, 16, 18, 20. Accordingly, in the same vertical plane as the respective side member 16 of the frame, the first linkage 38 extends perpendicularly upward from the frame side member 16 and the second linkage 40 extends obliquely upward and forward from the first linkage 38 toward the open end of the frame. This positions the passenger platform at an elevated height greater than achievable by either of the two linkages alone, and near the open end of the frame 12.

The transverse distance between the side members 14, 16 of the frame 12 from the open end thereof to the central cross-member 18 of the frame 12 is sufficiently wide to accommodate the stairway of aircraft for which the lift is intended for use. This way, in preparation for use of the lift, the frame 12 is rolled into a position in which the portions of the side members 14, 16 projecting past the central cross-member 18 to the open end of the frame act to straddle opposing sides of the deployed aircraft stairway. With the frame so positioned and the passenger platform in its fully lowered position of FIGS. 1 to 4, the ramp assembly 102 can be lowered from its stowed position of those figures into its deployed position shown in FIGS. 5 through 10. That is, the free end of the ramp opposite its coaxial pivotal connections to the end cross-member 20 of the frame is pivoted about those connections to extend the ramp's floor panel 108 in a direction pointing outward from the frame until the free end of the ramp sits upon the ground at a distance outward from the end cross-member. In this position, the ramp assembly 102 forms a sloped pathway angling obliquely upward from the ground to atop the end cross-member 20.

Giving consideration to the ramp's deployed position of FIGS. 5 through 10 and the passenger platform's lowered position of FIGS. 1 through 4, it will be appreciated that the floor panel 32 of the lowered platform 30 forms a horizontal continuation of the sloped pathway started by the ramp assembly, thereby providing a full pathway connection from the end cross-member 20 to the central cross-member 18. The deployed ramp assembly and lowered passenger platform accordingly cooperate with one another and the end cross-member between them to form a substantially uninterrupted pathway from the ground up onto the frame and onward to the central cross-member thereof. Accordingly, passengers that do not require the lift functionality of the apparatus to board or disembark the aircraft can still enter or exit the stairway even with the apparatus positioned to straddle the bottom of the stairs, as the lowered platform and deployed ramp provide a safe unobstructed pathway from where the bottom stairs lie adjacent the central cross-member, over the remaining portion of the lift frame, and then down to the ground.

When a passenger requiring assistance is to be lifted to the aircraft doorway or access opening, with the frame of the lift straddling the stairway as described above, the ramp is likewise deployed with the platform starting in the fully lowered position so that the passenger and an assistant can travel up the ramp to gain access to the platform. At this point, controls for operating the linkages are employed to lift the platform up to the aircraft access opening. Due to the use of not one, but two controllable linkages between the frame and the platform, a wide variety of platform height and longitudinal position combinations relative to the frame are attainable, thus allowing use of the lift at the foot of the stairway for various aircraft having different door heights, stairway slope, etc. For unloading a passenger from an aircraft, the apparatus is positioned as described at the foot of the stairway, the ramp is lowered, the platform is raised to the aircraft door, and the passenger is moved onto the platform and safely lowered down to the frame for return to ground level via the lowered ramp.

The lift is thus operable even with an aircraft stairway deployed, and can remain in place at the stairway through the full boarding or disembarking process without interfering with stairway access by passengers not requiring the lift assistance of the apparatus. This is presents a time saving advantage, as there is no need to wait for a lift apparatus to approach or withdraw from the useful position adjacent the aircraft between aircraft boarding or disembarking by passengers that require assistance, and those who do not.

The coil springs of the apparatus are used to bias each of the linkages 38, 40 out its default lowered position parallel to the frame side member 16 and toward its fully extended position. The actuator coil spring 80, 92 of each parallelogram linkage is thus a compression spring acting to force the respective pair of stop plates 82-83, 100-101 apart to extend the piston rod of the respective actuator 74, 76 from the cylinder thereof. This reduces the amount of force required from the hydraulic actuators to lift a passenger from the lowered position and maintain an elevated position after being so lifted. In one embodiment, the characteristics of the springs are selected to approximate balancing an estimated maximum load of the apparatus structure itself during lift operations, plus 1.5 times an estimated average passenger weight. An actual passenger load less than these design values can thus be lifted without requiring fluid pressure in the lifting directions of the actuators, and only using fluid pressure in the other direction to effect stopping of the lift at any given position, thus reducing energy consumption in the hydraulic system. For loads exceeding the design values, energy consumption for to produce sufficient force in the lifting direction is less than it would be without the spring biasing of the linkages.

Known hydraulic control techniques are employed to provide operator controls over the extension and retraction of the hydraulic actuators and to automatically support the platform and any load thereon in a balanced stationary position absent any operator input reflecting a desired motion. A lock down mechanism is also provided for securing the platform in its fully lowered position against the bias of the coil springs, and preferably requires a hydraulic input to unlock the platform to ensure the presence of hydraulic pressure for fixing the position of the platform in the absence of operator input, thus preventing inadvertent springing of the platform out of its initial lowered position. Lock down of the platform prevents un-intentional actuation with the ramp in the stowed position.

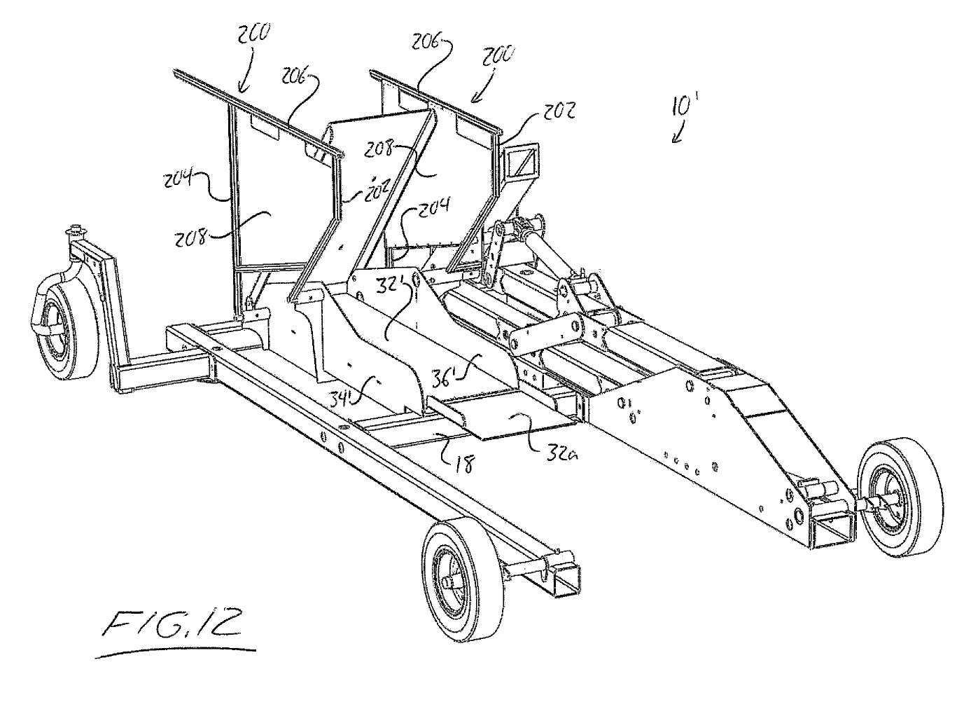

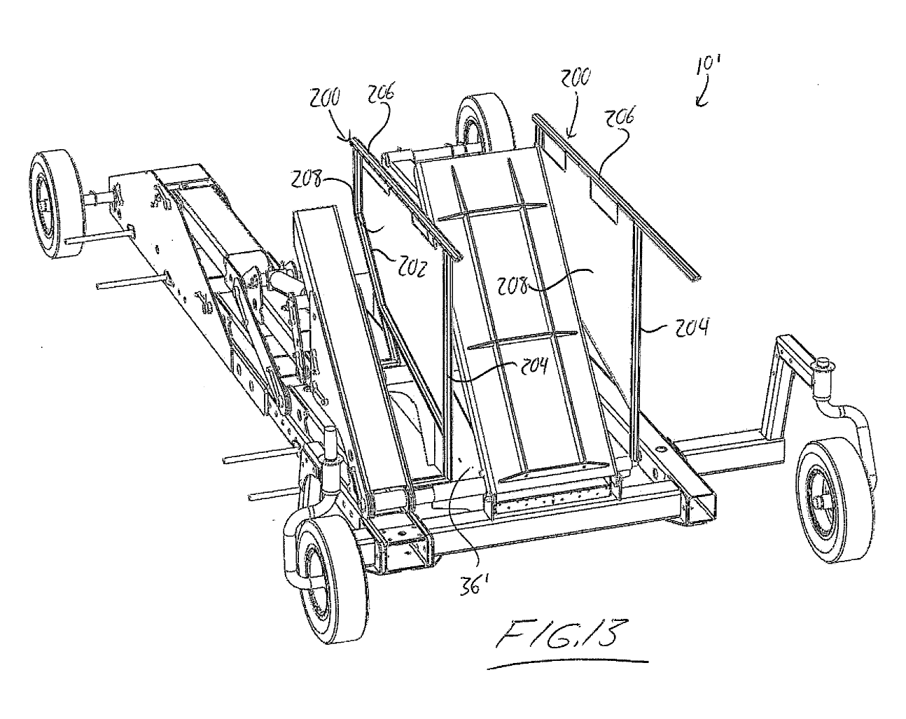

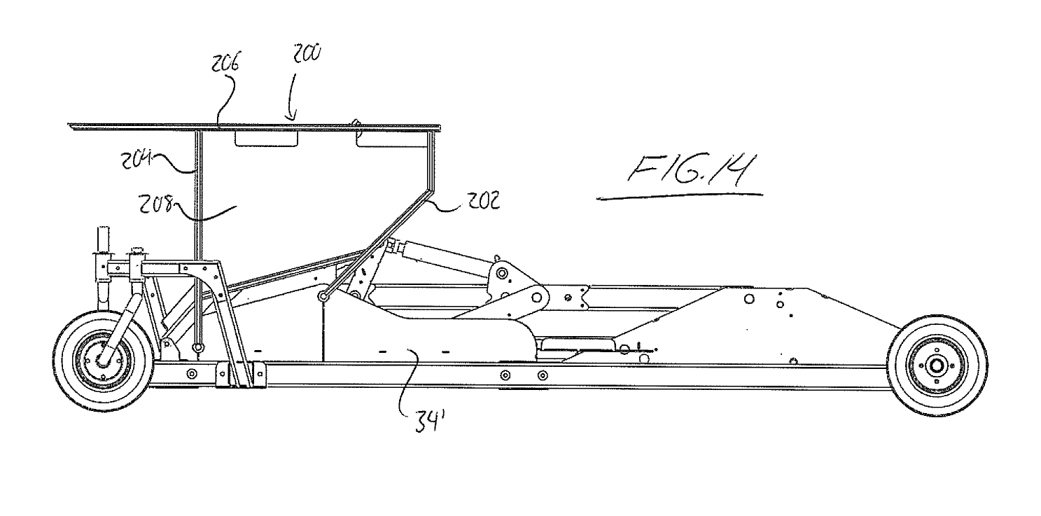

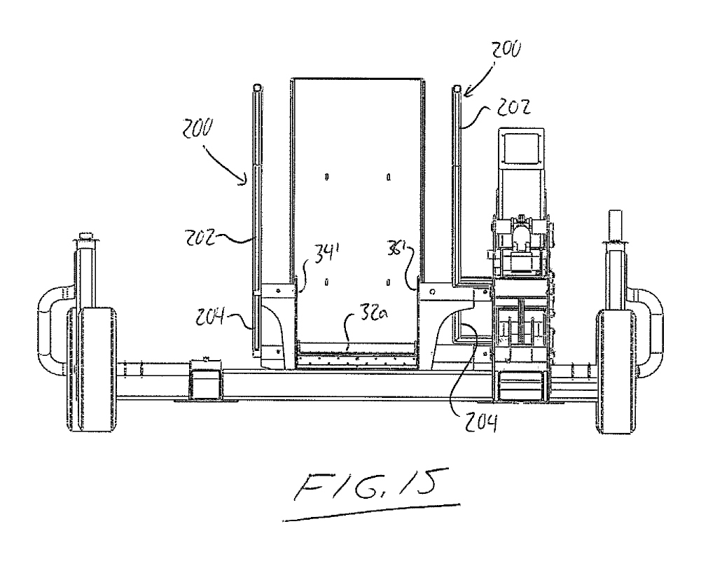

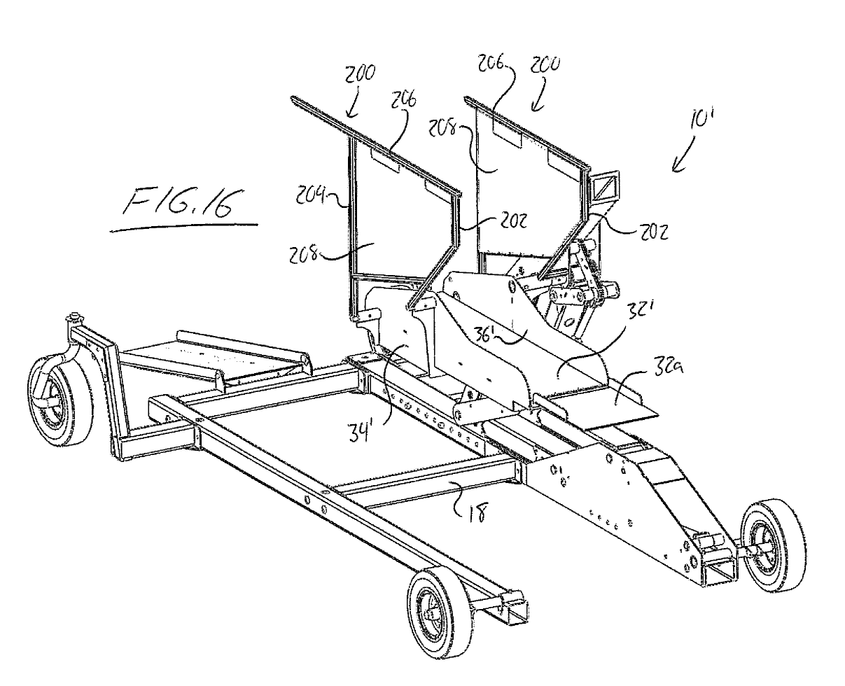

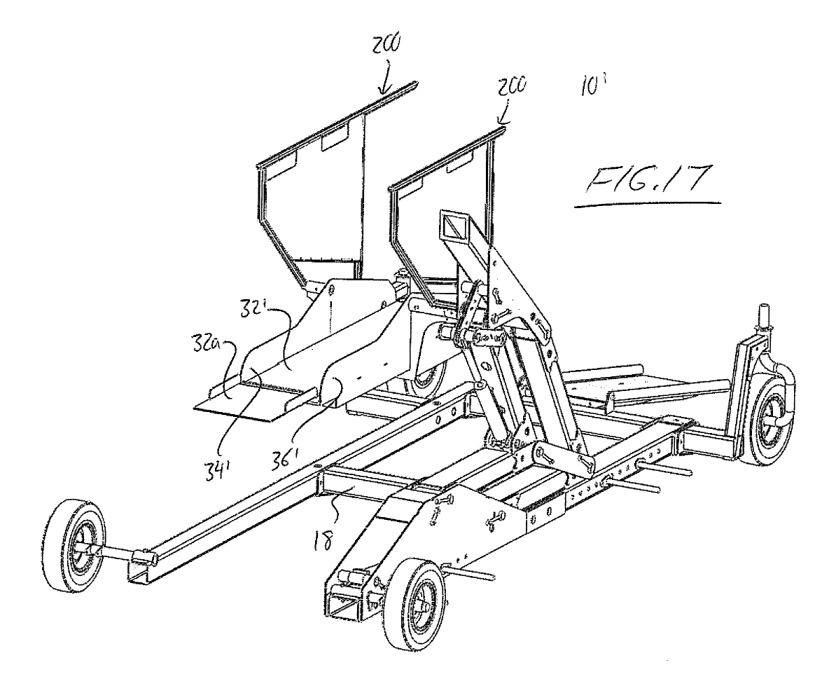

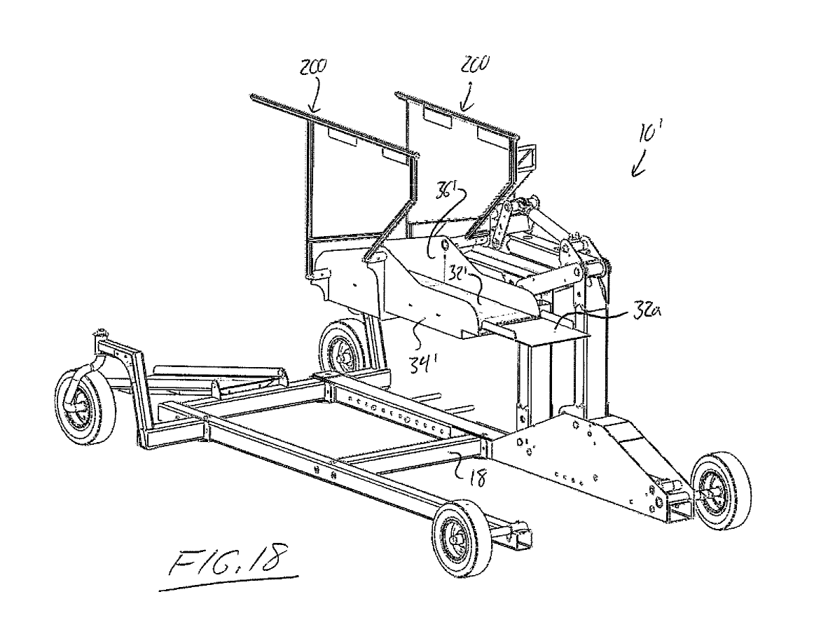

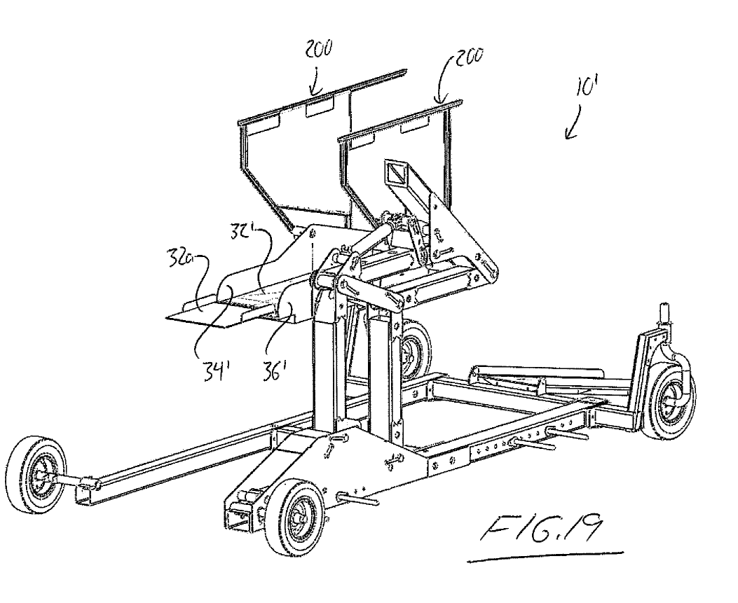

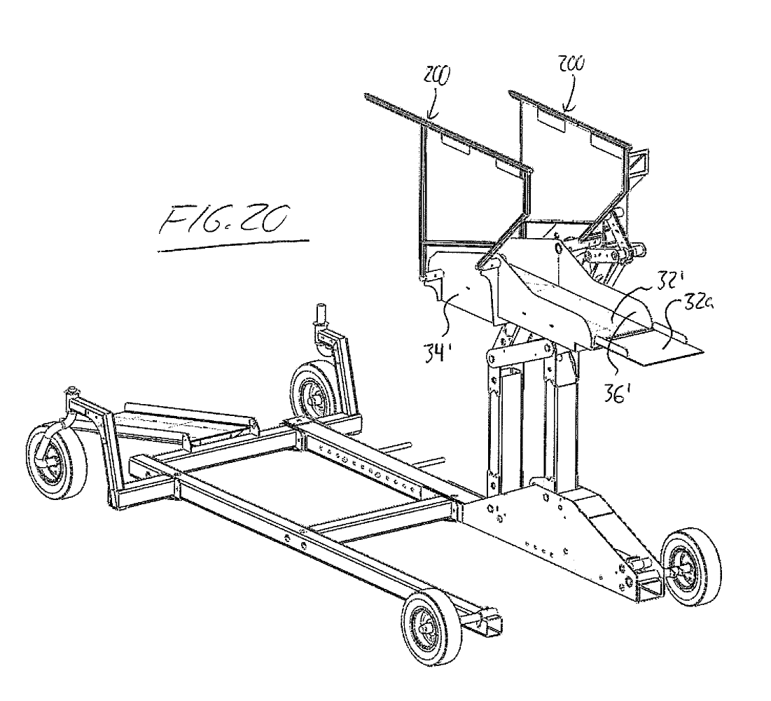

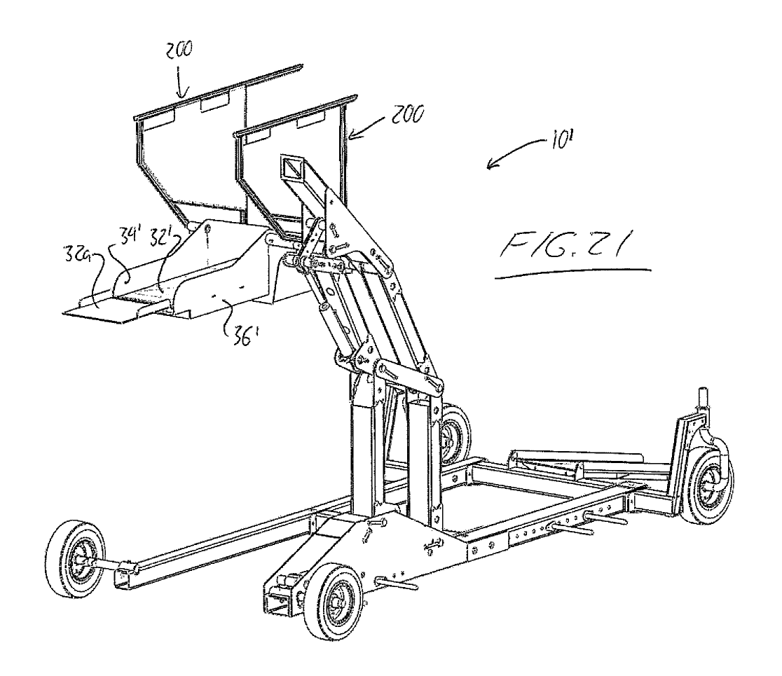

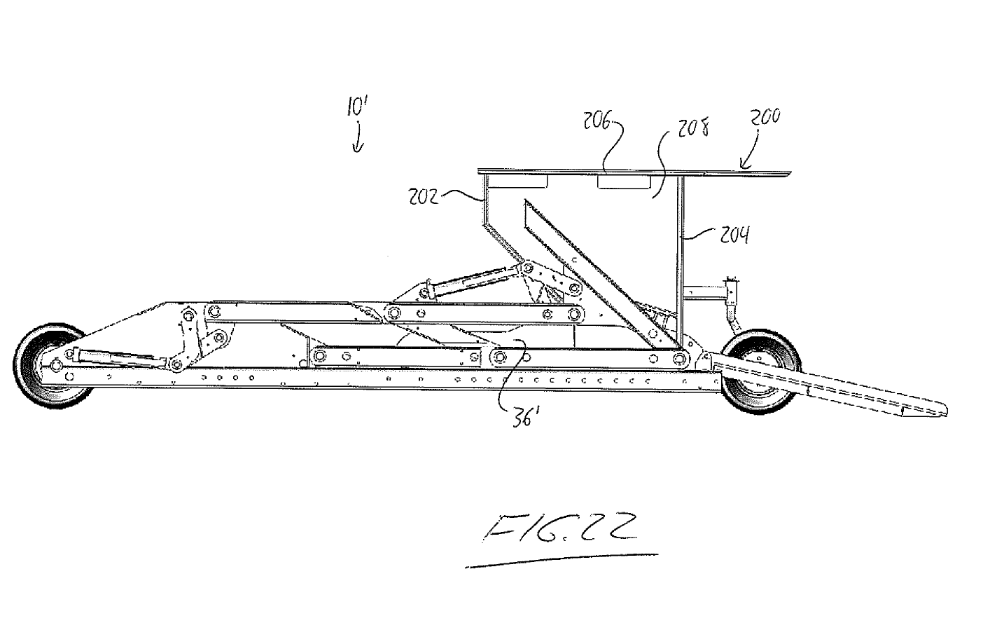

FIGS. 12 through 22 show a second embodiment passenger lift 10′ that differs from the first embodiment primarily in that it lacks any mechanism for biasing the linkages out their lowered positions into their extended positions. Accordingly, the second embodiment lift 10′ lacks the coil springs and associated stop plates of the first embodiment. Without a biasing mechanism, the weight of the platform and linkages will thus automatically bias the linkages and platform into their lowered positions. Accordingly, the second embodiment also lacks a lock down mechanism for securing the platform and linkages in such positions. The second embodiment relies purely on the action of the hydraulic cylinders to extend the linkages and raise the passenger platform.

Other differences in the second embodiment lift 10′ include the of a solid (non-perforated) floor panel 32′ instead of the mesh or grating of the first embodiment, the floor panel 32′ having a suitable non-slip top surface with an unsmooth finish or coating to provide significant frictional slip-resistance between the floor panel and passenger feet, wheelchair wheels, etc. that may ride on the passenger platform. Instead of use of a stop pin on the platform walls to cooperate with a slot in the ramp assembly side wall to define the stowed position of the ramp, the ramp instead rests against rear ends of the platform side walls near the closed end of the frame when the ramp is stowed. In the second embodiment, the platform side walls share the same general height and shape. The second embodiment also features a floor panel extension 32a carried on the platform and jutting from the front end of the floor panel 32′ to reach a short distance over the central cross-member 18 of the frame toward the open end of the frame when the platform is in the lowered position.

The second embodiment also illustrates hand rail and safety barrier assemblies 200 mounted at positions at the exterior sides of the side walls 34′, 36′ of the platform (i.e. to the sides of the walls facing away from the floor panel between the walls). Each assembly 200 features uprights 202, 204 spaced horizontally along the respective platform side wall, and a top rail 206 spanning horizontally between the two uprights 202, 204 at upper ends thereof at a height above the top of the platform side walls. The top rails 206 of the assemblies can be gripped by riders of the platform, and a plate 208 or other barrier spans down from the top rail to fill the open space between the uprights to cooperate with the uprights and top rail to provide a safety barrier blocking a rider from falling sideways from the platform.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A passenger lift for loading a passenger into and out of a structure having an elevated access opening, the passenger lift comprising:
a frame having a first end, and a second end opposite the first end;
wheels rotatably attached to the frame for rolling engagement with ground to enable travel of the frame over the ground;
a first parallelogram linkage comprising a first pair of parallel arms each having a first pivotal connection to the frame proximate the first end thereof, and a first output link pivotally connected between the first pair of parallel arms at a first distance from the first pivotal connections;
a second parallelogram linkage comprising a second pair of parallel arms each pivotally carried on the output link of the first parallelogram linkage, and a second output link pivotally connected between the second pair of parallel arms at a second distance from the second pivotal connections;
a passenger platform carried on the second parallelogram linkage by third pivotal connections pivotally connecting the passenger platform to the second parallelogram linkage at the second output link;
a first actuation device coupled to the first parallelogram linkage and operable to effect movement thereof relative to the frame by pivoting of the first pair of parallel arms about the first pivot points; and
a second actuation device coupled to the second parallelogram linkage and operable to effect movement thereof relative to the first parallelogram linkage by pivoting of the second pair of parallel arms about the second pivot points;
the passenger platform, by pivoting of the parallel arms of the parallelogram linkages relative to the frame, being movable between a lowered position, in which the parallelogram linkages extend toward the second end of the frame from the first pivotal connections to position the platform adjacent the second end of the frame, and raised positions in which the platform is situated nearer the first end of the frame, and at a greater elevation, than in the lowered position.

2. The passenger lift of claim 1 comprising a ramp device carried on the frame adjacent the second end thereof and deployable to form a pathway from the ground to where the platform resides when in the lowered position.

3. The passenger lift of claim 1 wherein the frame is open at the first end thereof and defines a gap that extends between side members of the frame from the open first end thereof to a location adjacent to where the platform resides when in the lowered position, whereby the platform forms an approach to the gap when the platform is in the lowered position.

4. The passenger lift of claim 1 wherein the first actuation device comprises a first hydraulic actuator connected between the frame and the first parallelogram linkage, and the second actuation device comprises a second hydraulic actuator connected between the first and second parallelogram linkages.

5. The passenger lift of claim 1 wherein the platform is supported on the frame from only one side of the platform.

6. A passenger lift for loading a passenger into and out of a structure having an elevated access opening that is also accessible by a staircase, the passenger lift comprising:
a frame having a first end, and a second end opposite the first end;
wheels rotatably attached to the frame for rolling engagement with ground to enable travel of the frame over the ground;
a passenger platform carried on the frame and movable relative thereto between a lowered position and raised positions in which the platform is situated nearer the second end of the frame, and at a greater elevation, than in the lowered position;
wherein the frame is open at the first end thereof and defines a gap that extends between side members of the frame from the open first end thereof to a location adjacent to where the platform resides when in the lowered position, the gap being sufficiently wide between the side members of the frame to accommodate a lower end of the staircase, whereby the platform forms an approach to the staircase when the platform is in the lowered position and the frame is positioned to receive the lower end of the staircase between the side members.

7. The passenger lift of claim 6 comprising a ramp device carried on the frame adjacent the second end thereof and deployable to form a pathway from the ground to where the platform resides when in the lowered position.

8. The passenger lift of claim 6 comprising a cross-member spanning across the gap at an end thereof opposite the open second end of frame

9. The passenger lift of claim 8 wherein an elevation of the platform, when in the lowered position, corresponds to an elevation of the cross-member.

10. The passenger lift of claim 7 wherein the ramp device is carried on a cross-member extending between the side members adjacent the second end of the frame and movable into and out of a stowed position raised from the ground.

11. The passenger lift of claim 10 wherein the ramp is pivotally mounted on the cross-member to swing between the stowed position, in which the ramp extends toward the first end of the frame in a position overlying the platform's lowered position, and a deployed position sloping down to the ground from the cross-member in a direction away from the first end of the frame.
